(19) United States
(12) Patent Application Publication
(10) Pub. No.: US 2016/0306485 A1
(43) Pub. Date: Oct. 20, 2016

(54) MULTI-SCALE DIGITIZER USING 3D MAGNETIC FORCE SENSOR AND MAGNETIC FORCE PEN

(71) Applicant: TRAIS CO., LTD., Ansan-si, Gyeonggi-do (KR)

(72) Inventors: Sung Yeop JOUNG, Daejeon (KR); Hong Chae KIM, Ansan-si (KR); Kwang Gu LEE, Ansan-si (KR)

(73) Assignee: TRAIS CO., LTD., Ansan-si, Gyeonggi-do (KR)

(21) Appl. No.: 14/781,070

(22) PCT Filed: May 16, 2014
(86) PCT No.: PCT/KR2014/004407

§ 371 Date: Sep. 29, 2015

(30) Foreign Application Priority Data
Feb. 21, 2014 (KR) 10-2014-0020305
Apr. 24, 2014 (KR) 10-2014-0049382

(51) Int. Cl. G06F 3/041; G06F 3/0354; G06F 3/046; G06F 3/0346

(52) U.S. Cl. CPC G06F 3/0416; G06F 3/0414; G06F 3/0346; G06F 3/03545; G06F 3/046

(57) ABSTRACT

Provided is a multi-scale digitizer using a 3D magnetic force sensor and a magnetic force pen, wherein one or more magnetic force sensors are installed inside a recognition device, and a change in a magnetic field of an external input unit with a magnetic material installed therein is measured through the sensors to detect a position of the external input unit. Since the digitizer capable of detecting position information of an external input unit by using the magnetic force sensors installed inside the recognition device is implemented, there is no need to provide a separate digitizer panel, and thus, a display device may be reduced in weight and thickness.

### TECHNICAL FIELD

The present invention relates to a multi-scale digitizer using a three-dimensional (3D) magnetic force sensor and a magnetic force pen, and more particularly, to a multi-scale digitizer using a 3D magnetic force sensor and a magnetic force pen, in which one or more magnetic force sensors are installed inside a recognition device, and a change in a magnetic field of an external input unit with a magnetic material installed therein is measured through the sensors to detect a position of the external input unit.

### BACKGROUND TECHNOLOGY

A digitizer, a type of input device used in display equipment, refers to a device having an matrix type electrode structure, reading X and Y coordinates on a matrix when a user moves a pen or a cursor, and transferring a position signal of the input device to a control unit to perform a corresponding command.

The digitizer is also called a touch panel or a tablet in a broad sense, and is classified as a resistive digitizer, a capacitive digitizer, and a magnetic digitizer according to position detection schemes. However, the digitizer may be distinguished from a touch panel so as to be used according to circumstances.

A display device of display equipment such as mobile terminals or tablet PCs includes a cover glass, a touch panel, a liquid crystal panel, and a digitizer, and with the recent development of display industries, display devices or display equipment integrating these elements or differentiating configurations of these elements have emerged.

However, when a touchscreen type digitizer is implemented by installing a separate magnetic force sensor panel, the number of panels to be attached increases, making a structure of the device complicated, increasing manufacturing cost, and causing a difficulty in repairing or replacing elements when an error occurs.

### TECHNICAL SOLUTIONS

Accordingly, the present invention provides a multi-scale digitizer using a 3D magnetic force sensor and a magnetic force pen, for detecting position information of an external input unit by sensing a change in a magnetic field due to the external input unit through a magnetic force sensor installed in a recognition device without having a separate digitizer panel.

The present invention also provides a multi-scale digitizer using a 3D magnetic force sensor and a magnetic force pen, having a function of detecting handwriting and drawing information by a recognition device when handwriting and drawing are performed on general paper and imaging the detected handwriting and drawing information, regardless of presence and absence of a display in the recognition device, rather than a digitizer scheme of inputting information to a surface of a display provided in the corresponding recognition device by using an external input unit.

The present invention also provides a multi-scale digitizer using a 3D magnetic force sensor and a magnetic force pen, for setting a region as the outermost part when a boundary of a handwriting region is designated in performing handwriting on an outer side of a recognition device with a magnetic force pen, and displaying an enlarged or reduced image on a display of the recognition device.

In one general aspect, a multi-scale digitizer using a 3D magnetic force sensor and a magnetic force pen includes a recognition device and an external input device, wherein one or more magnetic force sensors installed in the recognition device include a magnetic field sensor module 121 mounted on an inner surface of an enclosure of the recognition device, configured to measure a magnetic force vector and a magnetic force variation in a three-dimensional (3D) direction emitted from the external input unit and amplify a measured signal; a sensor communication module installed inside the enclosure of the recognition device and configured to adjust the signal of the magnetic force vector and the magnetic force variation measured by the magnetic sensor module; and a recognition device auxiliary control module configured to receive a measurement value of the magnetic force vector and the magnetic force variation output from the sensor communication module 122 and including a position detection algorithm for calculating spatial coordinates of the external input unit by comparing the received measurement value with a magnetic force vector spatial distribution data stored in the recognition device, wherein the recognition device visually displays spatial coordinates of the external input unit on a display by executing a multi-magnification coordinates recognition program for user recognition, and stores the spatial coordinates of the external input unit as an image or an electronic file.

The magnetic force sensor may be installed to be stacked inside the enclosure having a polygonal shape in which an upper surface and a lower surface parallel to each other are present.

The external input unit may include a cylindrical body; a magnetic material kept inside the body and generating a magnetic field that may be sensed by the recognition device; and an ink tip attached to an end portion of the body and having ink in an internal passage thereof.

The magnetic material may be formed of any one among a neodymium (Nd) alloy, an iron (Fe) alloy, a samarium (Sm) alloy, a cobalt (Co) alloy, a platinum (Pt) alloy, a manganese (Mn) alloy, a bismuth (Bi) alloy, a barium (Ba) alloy, and a nickel (Ni) alloy, and may be formed to have any one among a cylindrical shape, a conic shape, a truncated conic shape, a tube shape, a spherical shape, a hemispherical shape, and a square shape.

The ink tip may be formed of any one of materials among graphite, iron sulfate (FeSO₄), a tannic acid (C₁₄H₁₁O₉), a gallic acid (C₇H₆O₅), phenol (C₆H₅OH), rubber, aniline blue, auramine, eosin, titanium dioxide, iron sesquioxide, and synthetic tar dye.

The sensor communication module may discriminately recognize analog signal information of voltages and currents received from the magnetic field sensor module according to each magnetic field sensor module and accumulate the input currents and voltages, and when the accumulated currents and voltages are equal to or greater than a preset value, the sensor communication module may convert the signals through a method of outputting digital information.

The recognition device may use any one of a 3D coordinates conversion method of measuring a position of the external input unit by comparing a spatial distribution of magnetic force vectors and magnetic force variations appearing due to a difference between relative positions of the external input unit and the magnetic field sensor module and magnetic force vectors and magnetic force variations sensed by one or more magnetic field sensor modules, and a triangulation method of detecting a position of the external input unit by triangularly measuring magnetic force vectors and magnetic force variation values received from a plurality of magnetic sensor modules.

Other features and aspects will be apparent from the following detailed description, the drawings, and the claims.

### Advantageous Effects

As described above, according to the present invention, since the digitizer capable of detecting position information of an external input unit by using the magnetic force sensors installed inside the recognition device is implemented, there is no need to provide a separate digitizer panel, and thus, a display device may be reduced in weight and thickness.

In addition, since an output of handwriting or drawing generally performed on paper is stored in the form of an electronic file in the recognition device, data can be conveniently collected and stored in workplaces, schools, and public offices.

### DESCRIPTION OF DRAWINGS

FIG. 1 is a perspective view illustrating a state in which a multi-scale digitizer according to an embodiment of the present invention is used.

FIG. 2 is a plan view illustrating an internal structure of a recognition device including a display and a magnetic force sensor.

FIG. 3 is a perspective view illustrating a configuration of the magnetic force sensor.

FIG. 4 is a perspective view illustrating an internal structure of a magnetic force sensor module.

FIG. 5 is a flow chart illustrating sensing and processing a magnetic force vector and a variation signal by the magnetic force sensor.

FIG. 6 is a graph illustrating a spatial distribution of magnetic force generated by a magnetic force pen in an X axis direction.

FIG. 7 is a graph illustrating a spatial distribution of magnetic force generated by a magnetic force pen in a Y axis direction.

FIG. 8 is a graph illustrating a spatial distribution of magnetic force generated by a magnetic force pen in a Z axis direction.

FIG. 9 is a cross-sectional view illustrating an internal structure of an external input unit including a magnetic material and a pen tip.

FIG. 10 is a perspective view illustrating a principle of recognizing a position of an input unit moving on external paper by a recognition device.

FIG. 11 is a perspective view illustrating a principle of recognizing a boundary line of a handwriting region of an input unit by a recognition device.

### BEST MODE

Hereinafter, a multi-scale digitizer (hereinafter, referred to as a “digitizer”) using a three-dimensional magnetic force sensor and a magnetic force pen according to an embodiment of the present invention will be described.

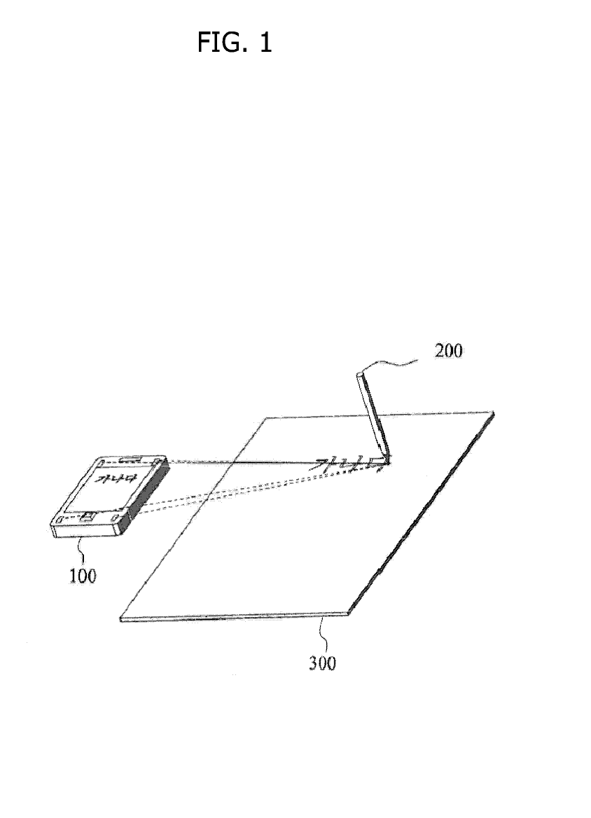

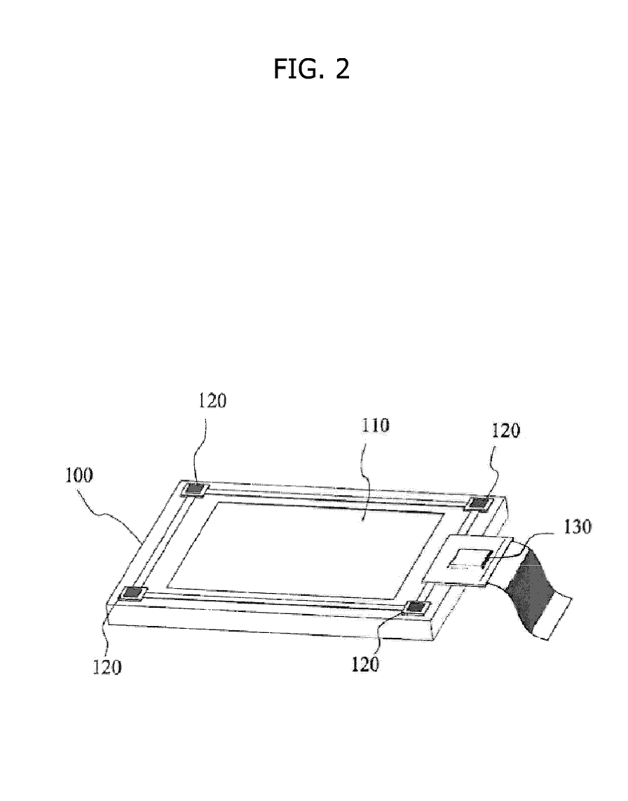

FIG. 1 is a perspective view illustrating a state in which a multi-scale digitizer according to an embodiment of the present invention is used, and FIG. 2 is a plan view illustrating an internal structure of a recognition device in which a display and a magnetic force sensor are installed.

One or more magnetic force sensors 120 are installed in a recognition device 100, and recognize a position and a movement of an external input unit 200 by sensing a magnetic force generated by the external input unit 200 moving outside. In general, the magnetic force sensors are installed on an inner surface of an enclosure forming a case of the recognition device 100.

The magnetic force sensor 120 is stacked and installed inside the enclosure having a polygonal shape, a spherical shape, and an oval shape including an upper surface and a lower surface parallel to each other.

When handwriting is performed on general paper 300 through the external input unit 200 inside a range of a sensing region of the recognition device 100, the magnetic force sensor 120 may detect a position of the external input unit 200 equipped with a magnetic material, store a trace of a movement, and display handwriting contents on a display unit 100 of the recognition device 100. The sensed handwriting contents may be converted into digital data and stored in the form of an electronic document. The external input unit 200 of the present invention refers to a magnetic force pen generating a magnetic field.

In the present invention, it is assumed that three magnetic force sensors 120 are positioned at three corner portions inside the recognition device 100. However, a larger number of the magnetic force sensors 120 may be provided or positions thereof may be varied. The recognition device 100 described in the present invention may be a general smartphone or tablet PC including the display 110 to visually display data, and here, the magnetic force sensors 120 may be positioned at edges (bezel) not overlapping the display 110 to implement a digitizer.

The recognition device 100 stores spatial coordinates of the external input unit 200 calculated by the magnetic force sensors 120 through a recognition device control module 130, as an image or an electronic file, and magnify or reduces the image or the electronic file at multiple magnifications to display the image or the electronic file on the display 110. To this end, a multi-magnification coordinates recognition program is installed in the recognition device 100.

The multi-magnification coordinates recognition program used in the present invention has a 3D magnetic field sensing region ranging from 1 to 500 mm in radius based on the recognition device 100, sensing a change in a magnetic field inside a broad range.

Also, an algorithm allowing a user to align or correct an input position, an input available space, and an input space at an initial stage of handwriting or drawing or while the external input unit 200 is performing handwriting or drawing, and disregarding a signal of a magnetic substance outside of the range for handwriting or drawing set by the user. Thus, when the user writes outside of the paper 300, the recognition device 100 may not store it.

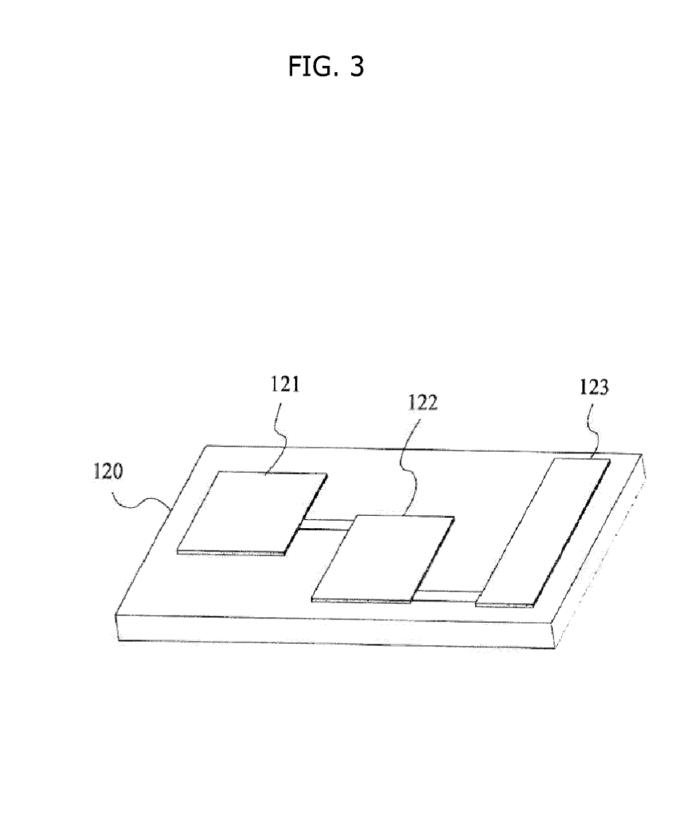

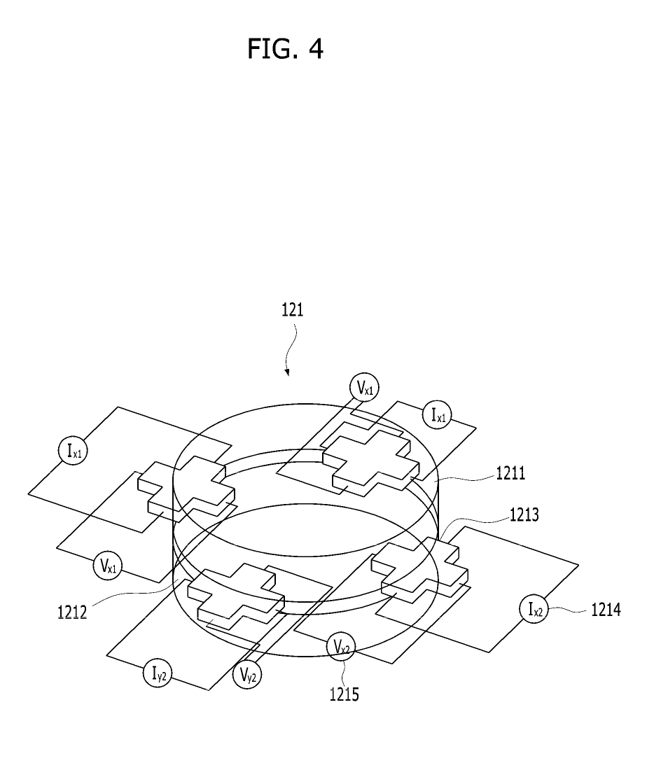

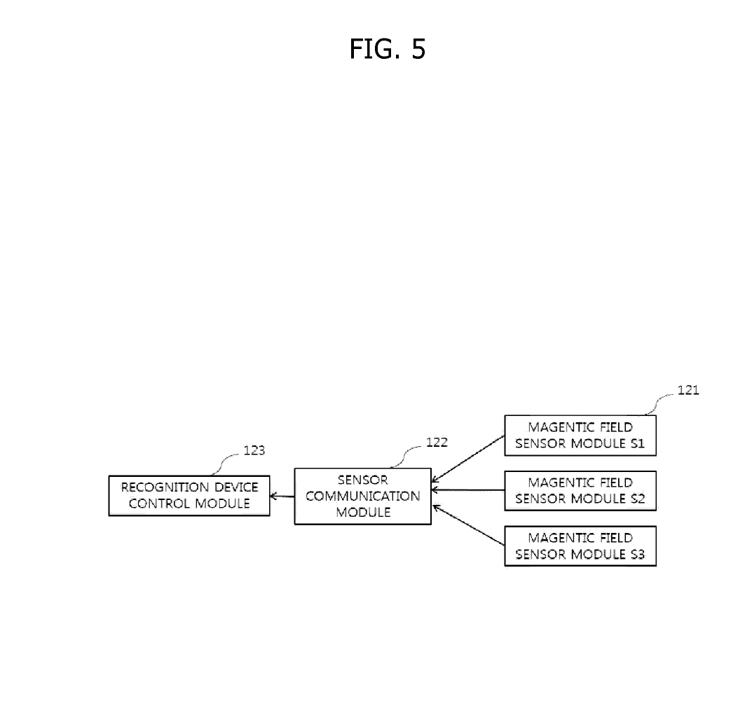

FIG. 3 is a perspective view illustrating a configuration of the magnetic force sensor, FIG. 4 is a perspective view illustrating an internal structure of a magnetic force sensor module, and FIG. 5 is a flow chart illustrating sensing and processing a magnetic force vector and a variation signal by the magnetic force sensor.

A magnetic sensor module 121 senses a distribution and a variation of a magnetic force vector by a magnetic substance included in the external input unit 200, amplifies a signal, and outputs the signal to a sensor communication module 122.

Upon receiving the signal, the sensor communication module 122 filters the signal in consideration of a magnitude of the signal and noise based on a surrounding environment, and stores and outputs the corresponding value at every predetermined time or at every predetermined period. The sensor communication module 122 has a function of converting an analog signal in the form of a voltage or a current output from the magnetic field sensor module 121 into a digital signal.

The sensor communication module 122 discriminately recognizes analog signal information of voltages and currents received from a plurality of magnetic field sensor modules 121 according to the magnetic field sensor modules 121. The sensor communication module 122 accumulates the input currents and voltages, and when the accumulated currents and voltages are equal to or greater than a preset value, the sensor communication module 122 converts the signals through a method of outputting digital information.

The information which has been converted into a digital signal is output in series or in parallel to a recognition device auxiliary control module 123. The recognition device auxiliary control module 123 detects a spatial position of the external input unit 200 on the basis of the received magnetic force information (distribution and variation of a magnetic force vector). The recognition device auxiliary control module 123 compares the input data with previously input magnetic force spatial distribution data to calculate spatial coordinates of the external input unit 200. To this end, 3D spatial magnetic force distribution data around the recognition device 100 is previously stored in the recognition device control module 130 (memory, storage device, etc.), and also, a position detection algorithm for calculating spatial coordinates of the external input unit 200 is installed therein.

The magnetic field sensor module 121 illustrated in FIG. 4 is a Hall effect sensor, having a structure in which four Hall effect electrodes 1213 are paired perpendicularly in a tap between a magnetic field absorption upper plate 1211 and a magnetic field absorption lower plate 1212 which are stacked and absorb an external magnetic field. When an external magnetic field passes through the magnetic field absorption upper plate 1211 and the magnetic field absorption lower plate 1212 in an X axis direction, Hall effect induction currents 1214 at positions X1 and X2 are measured to be opposite to each other. However, since a magnetic field in a Y axis direction is not changed, Hall effect induction currents 1214 at positions Y1 and Y2 are measured to be in the same direction.

When the external magnetic field passes in the Y axis direction, the Hall effect induction currents 1214 at positions Y1 and Y2 may be measured to be opposite to each other, and the hall effect induction currents 1214 at positions X1 and X2 may be measured to be in the same direction.

Also, when the external magnetic field passes in a Z axis direction (direction perpendicular to the X-Y plane), the Hall effect induction currents 1214 at positions X1 and X2 and Y1 and Y2 may be measured to be in the same direction. In this manner, 3D vectors of the external magnetic field may be simultaneously measured by measuring the magnitudes and directions of the Hall effect induction currents 1214.

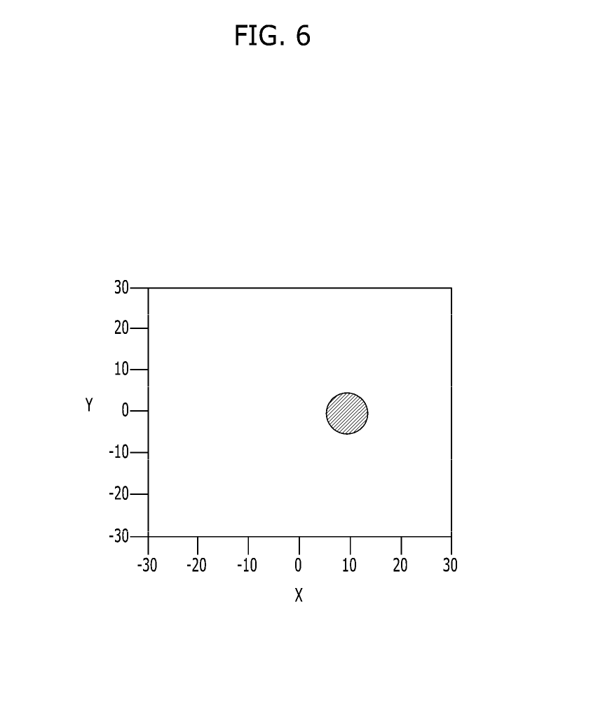

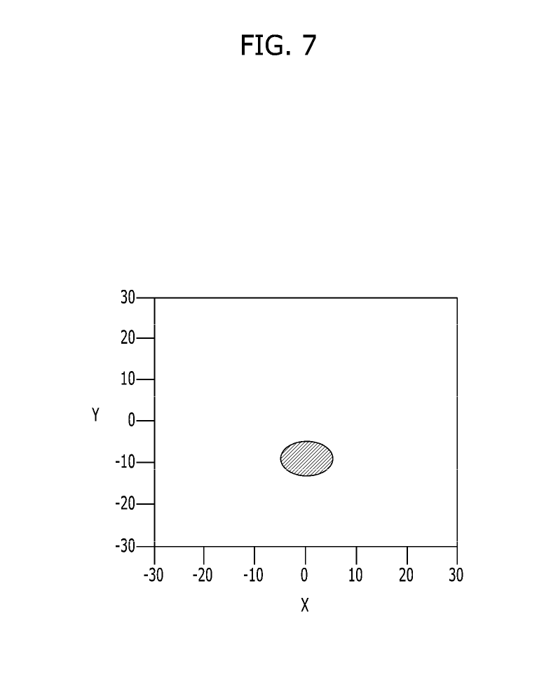

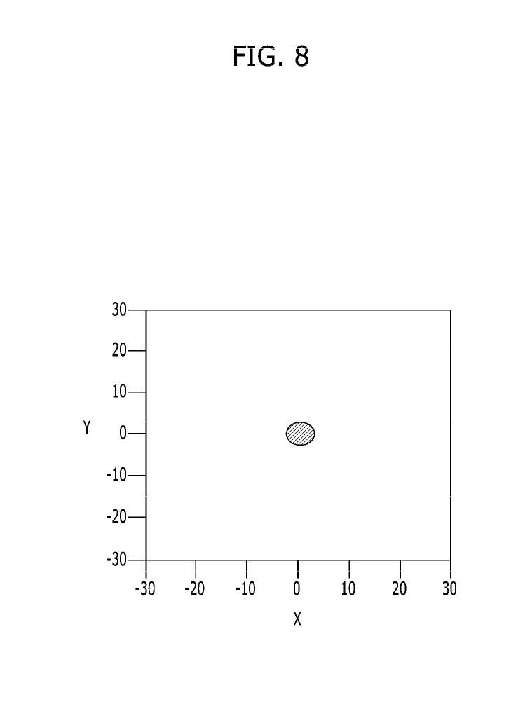

FIG. 6 is a graph illustrating a spatial distribution of magnetic force generated by a magnetic force pen in the X axis direction, FIG. 7 is a graph illustrating a spatial distribution of magnetic force generated by a magnetic force pen in the Y axis direction, and FIG. 8 is a graph illustrating a spatial distribution of magnetic force generated by a magnetic force pen in the Z axis direction.

As illustrated in FIGS. 6 through 8, a single magnetic sensor module 121 may simultaneously measure X, Y, and Z axis magnetic force distributions of the external input unit 200. The 3 axis magnetic force distributions may be stored in the magnetic field sensor module 121, and a unique magnetic force distribution according to a spatial position of the external input unit 200 may be compared therewith to sense a trace of the external input unit 200 on the external paper 300. Since the single magnetic field sensor module 121 senses a change in the magnetic fields in the 3 axis directions, a trace of the external input unit 200 may be tracked by using only the single magnetic field sensor module 121. However, the use of two or more magnetic field sensor modules 121 may enhance precision of recognition of a position of the external input unit 200.

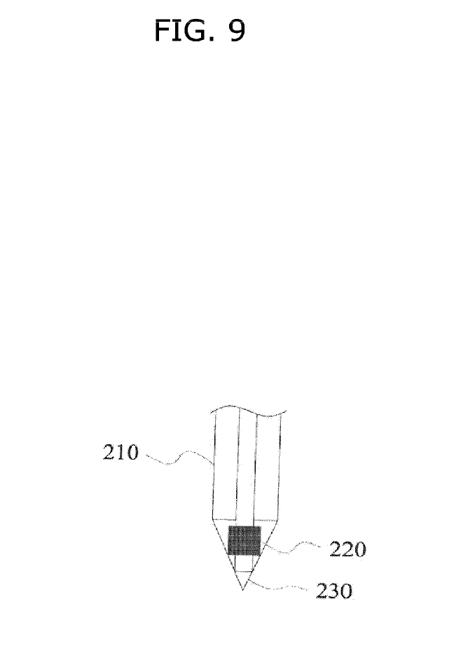

FIG. 9 is a cross-sectional view illustrating an internal structure of an external input unit including a magnetic material and a pen tip.

The external input unit 200 is a device generating a magnetic field that can be sensed by the recognition device 100. Preferably, the external input unit 200 is formed to be similar to a general ballpoint pen or a stylus pen. The user may grip the external input unit 200 similar to a pen with his or her hand and input an operation, while moving on the paper 300 as if he or she writes or draws a picture.

In the external input unit 200, a magnetic material 220 is kept inside a cylindrical body 210 similar to general writing materials.

The magnetic material 220 used in the present invention is formed of any one of a neodymium (Nd) alloy, an iron (Fe) alloy, a samarium (Sm) alloy, a cobalt (Co) alloy, a platinum (Pt) alloy, a manganese (Mn) alloy, a bismuth (Bi) alloy, a barium (Ba) alloy, and a nickel (Ni) alloy. The magnetic material 220 may have various shapes. For example, the magnetic material 220 may have a cylindrical shape, a conic shape, a truncated conic shape, a tube shape, a spherical shape, a hemispherical shape, and a square shape.

An ink tip 230 attached to an end of the body 210 extends in a length direction of the body 210, and ink of generally used writing materials is provided in an internal passage of the ink tip 230. An end portion of the ink tip 230 is sharp to facilitate writing. When the user writes or draws a picture, while contacting or producing friction on a surface of the paper 300, ink remains in portions where the ink tip 230 has passed through, whereby writing or a picture drawn by the user may be checked.

In order to leave a trace on the paper 300 by the ink tip 230, a colored material which may be able to leave a trail is used. The ink tip 230 is generally formed of any one of materials among graphite, iron sulfate (FeSO₄), a tannic acid (C₁₄H₁₁O₉), a gallic acid (C₇H₆O₅), phenol (C₆H₅OH), rubber, aniline blue, auramine, eosin, titanium dioxide, iron sesquioxide, and synthetic tar dye.

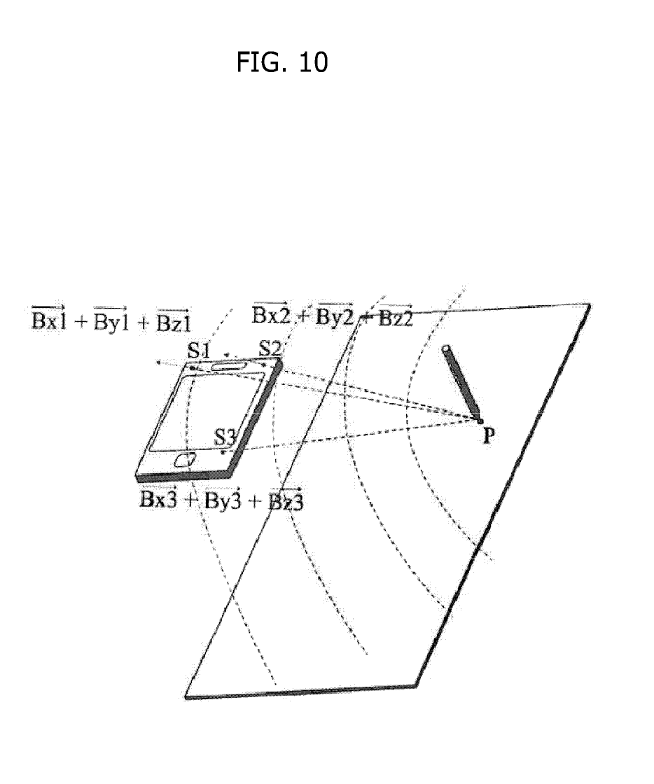

FIG. 10 is a perspective view illustrating a principle of recognizing a position of an input unit moving on external paper by a recognition device.

One or more magnetic force sensors 120 sense a distribution of a magnetic variation and a magnetic vector appearing due to a difference between relative positions of the external input unit 200 including the magnetic material 220 and the magnetic sensor 120. The magnetic force sensors 120 calculate a distance by using a 3D coordinate conversion method of measuring a position of the external input unit 200 by analyzing the sensed magnetic force vector and variation, or distances to the external input unit 200 on the handwriting plane are calculated with magnetic force vectors and variations input from three or more magnetic force sensors 120. In order to detect a position of the external input unit 200 by calculating the three pieces of distance information, a triangulation method is applied.

The magnetic material 220 of the external input unit 200 may uniformly maintain a magnetic field vector value B at a predetermined distance, and the magnetic force sensor 120 may sense input magnetic force information in three axes (X, Y, and Z) directions. Thus, sensing information of the magnetic force sensor 120 based on the magnetic material 220 may be analyze in the form of Bx, By, and Bz in the three axes directions. The recognition device 100 including the corresponding magnetic force sensor 120 already has information regarding the magnetic material 220, and thus, it may calculate required information by using the 3D coordinates conversion method and the triangulation method.

The 3D coordinates conversion method is a method of measuring a position of the external input unit 200 by comparing a spatial distribution of magnetic force vectors and magnetic force variations appearing due to a difference between relative positions of the external input unit 200 and the magnetic field sensor module 121 and magnetic force vectors and magnetic force variations sensed by one or more magnetic field sensor modules 121. The triangulation method is a method of detecting a position of the external input unit 200 by triangularly measuring magnetic force vectors and magnetic force variation values received from a plurality of magnetic sensor modules 121.

Spatial coordinates of the external input unit 200 calculated by the recognition device 100 are stored in units of minute time of 10 ms or less. A control unit of the recognition device 100 linearly connects the measured coordinates values to visually display handwriting or drawing information input through the external input unit 200.

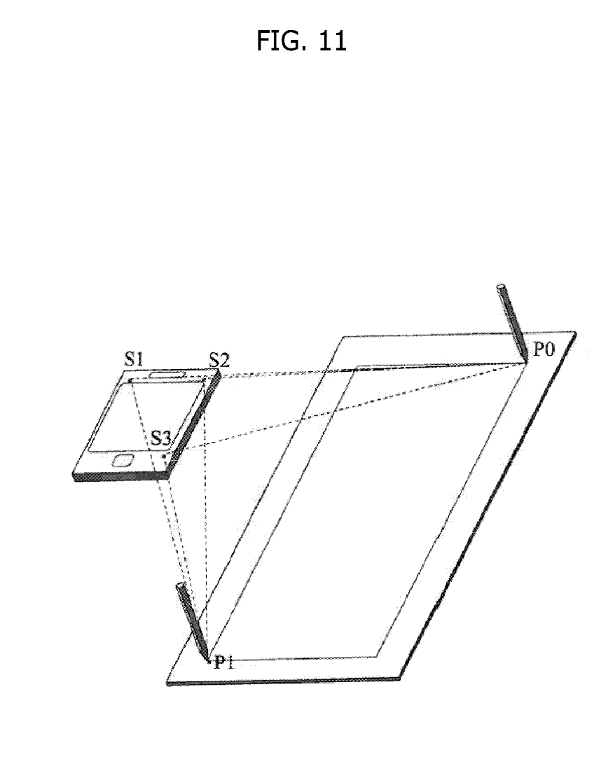

FIG. 11 is a perspective view illustrating a principle of recognizing a boundary line of a handwriting region of an input unit by the recognition device.

In FIG. 11, an embodiment in which the multi-scale digitizer system designates limit points determining a reduction or enlargement magnification when handwriting is performed on the external paper 300 is illustrated. When the user designates corresponding coordinates by positioning the external input unit 200 at the input limit points P0 and P1 on the external paper 300, an input unit magnification may be arbitrarily adjusted according to a size of the display 110 of the recognition device 100.

The recognition device 100 generates a virtual rectangle with the input limit points P0 and P1 input by the user as both end points of a diagonal line, and correspond the generated rectangle to the display 110 of the recognition device 100. Accordingly, when the user positions the input limit points P0 and P1 to be away from each other, a size of the rectangle is increased, and thus, when it is expressed on the display 110, a reduced image is displayed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are inside the scope of the following claims.

1. A multi-scale digitizer using a 3D magnetic force sensor and a magnetic force pen, comprising a recognition device and an external input device, wherein one or more magnetic force sensors installed in the recognition device include: a magnetic field sensor module mounted on an inner surface of an enclosure of the recognition device, configured to measure a magnetic force vector and a magnetic force variation in a three-dimensional (3D) direction emitted from the external input unit and amplify a measured signal; a sensor communication module installed inside the enclosure of the recognition device and configured to adjust the signal of the magnetic force vector and the magnetic force variation measured by the magnetic sensor module; and a recognition device auxiliary control module configured to receive a measurement value of the magnetic force vector and the magnetic force variation output from the sensor communication module and including a position detection algorithm for calculating spatial coordinates of the external input unit by comparing the received measurement value with a magnetic force vector spatial distribution data stored in the recognition device, wherein the recognition device visually displays spatial coordinates of the external input unit on a display by executing a multi-magnification coordinates recognition program for user recognition, and stores the spatial coordinates of the external input unit as an image or an electronic file.

2. The multi-scale digitizer of claim 1, wherein the magnetic force sensor is installed to be stacked inside the enclosure having a polygonal shape in which an upper surface and a lower surface parallel to each other are present.

3. The multi-scale digitizer of claim 1, wherein the external input unit includes a cylindrical body; a magnetic material kept inside the body and generating a magnetic field sensed by the recognition device; and an ink tip attached to an end portion of the body and having ink in an internal passage thereof.

4. The multi-scale digitizer of claim 3, wherein the magnetic material is formed of any one among a neodymium (Nd) alloy, an iron (Fe) alloy, a samarium (Sm) alloy, a cobalt (Co) alloy, a platinum (Pt) alloy, a manganese (Mn) alloy, a bismuth (Bi) alloy, a barium (Ba) alloy, and a nickel (Ni) alloy, and is formed to have any one among a cylindrical shape, a conic shape, a truncated conic shape, a tube shape, a spherical shape, a hemispherical shape, and a square shape.

5. The multi-scale digitizer of claim 3, wherein the ink tip is formed of any one of materials among graphite, iron sulfate (FeSO₄), a tannic acid (C₁₄H₁₁O₉), a gallic acid (C₇H₆O₅), phenol (C₆H₅OH), rubber, aniline blue, auramine, eosin, titanium dioxide, iron sesquioxide, and synthetic tar dye.

6. The multi-scale digitizer of claim 1, wherein the sensor communication module discriminately recognizes analog signal information of voltages and currents received from the magnetic field sensor module according to each magnetic field sensor module and accumulates the input currents and voltages, and when the accumulated currents and voltages are equal to or greater than a preset value, the sensor communication module converts the signals through a method of outputting digital information.

7. The multi-scale digitizer of claim 1, wherein the recognition device uses any one of a 3D coordinates conversion method of measuring a position of the external input unit by comparing a spatial distribution of magnetic force vectors and magnetic force variations appearing due to a difference between relative positions of the external input unit and the magnetic field sensor module and magnetic force vectors and magnetic force variations sensed by one or more magnetic field sensor modules, and a triangulation method of detecting a position of the external input unit by triangularly measuring magnetic force vectors and magnetic force variation values received from a plurality of magnetic sensor modules.
